(19) United States
(12) Patent Application Publication
(10) Pub. No.: US 2026/0006342 A1
(43) Pub. Date: Jan. 1, 2026

(54) ELECTRONIC DEVICE AND LONG-EXPOSURE VIDEO GENERATION METHOD THEREOF

(71) Applicant: ASUSTeK COMPUTER INC., Taipei City (TW)

(72) Inventors: Jo-Fan Wu, Taipei City (TW); Ting-Wei Hsu, Taipei City (TW)

(73) Assignee: ASUSTeK COMPUTER INC., Taipei City (TW)

(21) Appl. No.: 19/207,371

(22) Filed: May 14, 2025

(30) Foreign Application Priority Data
Jun. 28, 2024 (TW) 113124179

(51) Int. Cl. H04N 23/76

(52) U.S. Cl. CPC H04N 23/76

(57) ABSTRACT

An electronic device and a long-exposure video generation method thereof are provided. The method is adapted to the electronic device comprising an image capturing device and includes the following steps. N original frames are captured according to an input frame rate through the image capture device. M first reference frames are selected from the N original frames according to a first exposure target duration, wherein M is an integer greater than 1 and N is an integer greater than M. An image synthesis processing is performed on the M first reference frames to obtain a result frame. A long-exposure video with an output frame rate and comprising the result frame is generated.

### CROSS-REFERENCE TO RELATED APPLICATION

This application claims the priority benefit of Taiwan application serial no. 113124179, filed on Jun. 28, 2024. The entirety of the above-mentioned patent application is hereby incorporated by reference herein and made a part of this specification.

### BACKGROUND

### Technical Field

The disclosure relates to a long-exposure video generation method and an electronic device using the method.

### Description of Related Art

With the advancement of technology, electronic devices with image capture functions have become prevalent in modern people's lives. Users can obtain images or videos with different image effects by adjusting shooting parameters. For example, by adjusting the shutter speed, exposure duration, or other exposure parameters, images with a long exposure effect can be captured. The benefits of long exposure include capturing low-light scenes more clearly and creating night images with light trails. Generally, long-exposure photography is more commonly achieved with single image. If the user wants to maintain the long exposure effect in each frame of a video, extending the exposure time will inevitably reduce the video frame rate, leading to poor video smoothness. Conversely, to maintain video smoothness, it is essential to keep a relatively high frame rate. However, a high frame rate limits the exposure time of individual frames, preventing the video from achieving the desired long exposure effect.

For example, the video frame rate generally needs to be at least 30 FPS (30 frames per second) to maintain ideal video smoothness. Correspondingly, the maximum exposure time of each single frame image in a 30 FPS video is 1/30 second, so it is impossible to achieve a beautiful light track smear effect. If the exposure time of each single frame image in the video is extended to 1/10 second in order to obtain the light trail effect, the electronic device would record the video at a low frame rate (i.e. 10 FPS), resulting in poor video smoothness. Although the video frame rate can be adjusted through time-lapse processing to improve video smoothness, users are forced to accept changes in the sense of time.

### SUMMARY

The disclosure provides a long-exposure video generation method, which is adapted to an electronic device including an image capture device. The method includes the following steps. N original frames are captured according to an input frame rate through the image capture device. M first reference frames are selected from the N original frames according to a first exposure target duration, wherein M is an integer greater than 1 and N is an integer greater than M. An image synthesis processing is performed on M first reference frames to obtain a result frame. A long-exposure video with the output framerate that including the resulting image frame is generated.

The disclosure provides an electronic device, which includes an image capturing device and a processor. The processor is coupled to the image capture device. The processor is configured to perform the following operations. N original frames are captured according to an input frame rate through the image capture device. M first reference frames are selected from the N original frames according to a first exposure target duration, wherein M is an integer greater than 1 and N is an integer greater than M. An image synthesis processing is performed on M first reference frames to obtain a result frame. A long-exposure video with the output framerate that including the resulting image frame is generated.

Based on the above, in the embodiment of the disclosure, multiple reference frames may be extracted from the original frames according to the exposure target duration, and the multiple reference frames may be synthesized into one result frame in the long-exposure video. Therefore, without reducing the capture frame rate of the original frame, the disclosure may generate a long-exposure video with a dynamic long exposure effect, and the output frame rate of the long exposure effect may be equal to the input frame rate of the original frame. Based on this, the problem that the frame rate of long-exposure images is limited by extending the exposure time of a single frame may be solved.

### BRIEF DESCRIPTION OF THE DRAWINGS

FIG. 1 is a block diagram of an electronic device according to an embodiment of the disclosure.

FIG. 2 is a flowchart of a long-exposure video generation method according to an embodiment of the disclosure.

FIG. 3 is a flowchart of a long-exposure video generation method according to an embodiment of the disclosure.

FIG. 4 is a schematic diagram illustrating the corresponding relationship between the original frame and the result frame according to an embodiment of the disclosure.

FIG. 5 is a schematic diagram illustrating the corresponding relationship between the original frame and the result frame according to an embodiment of the disclosure.

FIG. 6 is a schematic diagram illustrating the corresponding relationship between the original frame and the result frame according to an embodiment of the disclosure.

FIG. 7 is a schematic diagram illustrating the corresponding relationship between the original frame and the result frame according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same component symbols are used in the drawings and descriptions to represent the same or similar parts. These embodiments are only part of the disclosure and do not disclose all possible implementations of the disclosure. Rather, these embodiments are merely examples of devices and methods within the scope of the application of the disclosure.

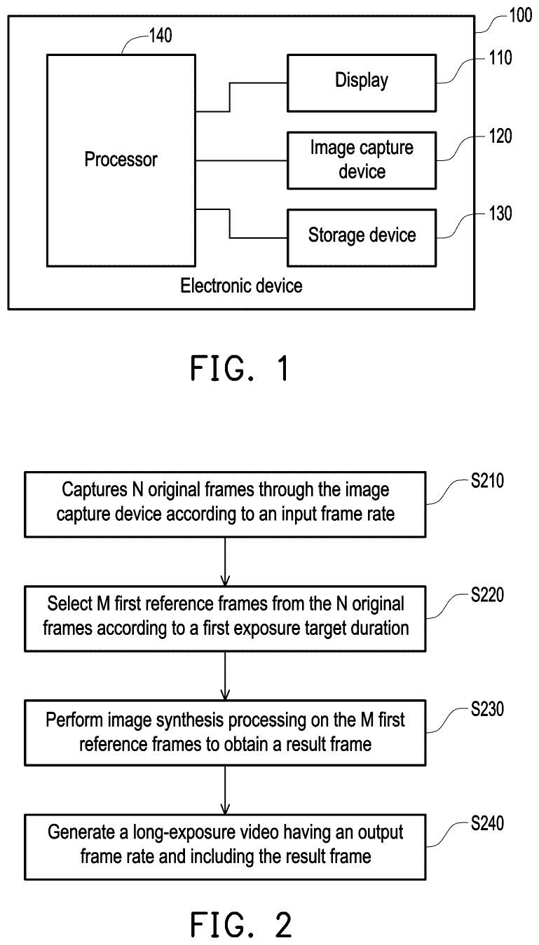

Referring to FIG. 1, the electronic device 100 may include a display 110, an image capture device 120, a storage device 130, and a processor 140. The electronic device 100 may be, for example, a smart phone, a digital camera, a tablet, a game console, an electronic wearable device, a photography device, or any other electronic device with an image capturing function, and the type of the electronic device 100 is not limited thereto.

The display 110 may be a liquid crystal display (LCD), a light emitting diode (LED) display, an organic light emitting diode (OLED), and other types of displays, which is not limited in the disclosure. The display 110 may be configured to display an operation interface or a live preview screen of a camera application.

The image capture device 120 is configured to capture images or videos, and may include lenses, image sensing elements, and other components. The lens may include an optical lens for controlling light paths. The image sensing element is configured to provide image sensing functions. The image sensing element may include a photosensitive element, such as a Charge Coupled Device (CCD), a Complementary Metal-Oxide Semiconductor (CMOS) element or other elements, which the disclosure is not limited to. The lens may collect imaging light on the image sensing element to achieve the purpose of capturing images.

The storage device 130 is configured to store files, images, instructions, program codes, software modules, etc., which may be, for example, any type of fixed or removable random access memory (RAM), read-only memory (ROM), flash memory, hard disk or other similar devices, integrated circuits, or combinations thereof.

The processor 140 is coupled to the display 110, the image capture device 120 and the storage device 130, and is, for example, a central processing unit (CPU), an application processor (AP), or other programmable devices. Purpose or special purpose microprocessor, digital signal processor (DSP), image signal processor (ISP), graphics processing unit (GPU) or other similar devices, integrated circuits or combinations thereof. In some embodiments, the processor 140 may execute instructions or program codes in the storage device 130 to implement each step of the long-exposure video generation method in the embodiments of the disclosure.

FIG. 2 is a flowchart of a long-exposure video generation method according to an embodiment of the disclosure. Referring to FIG. 2, the method of this embodiment may be executed by the electronic device 100 in FIG. 1. The details of each step in FIG. 2 will be described below with reference to the components shown in FIG. 1.

In step S210, the processor 140 may capture N original frames through the image capture device 120 according to the input frame rate. In some embodiments, in response to the electronic device 100 receiving a shooting instruction issued by the user, the image capture device 120 may continuously capture multiple consecutive original frames according to the input frame rate (unit: FPS). These consecutive original frames may be short exposure images respectively. The input frame rate is, for example, 30 FPS, 60 FPS or other frame rates, which is not limited by the disclosure. The N original frames may form a frame sequence according to their shooting order.

In step S220, the processor 140 may select M first reference frames from the N original frames according to a first exposure target duration, wherein M is an integer greater than 1 and N is an integer greater than M.

In some embodiments, the first exposure target duration may be a default value, manually set by the photographer, or determined based on shooting environment information. For example, the processor 140 may determine the first exposure target duration according to the ambient brightness, and the first exposure target duration may increase as the ambient brightness decreases. Furthermore, the length of the first exposure target duration is positively correlated with the number of first reference frames (i.e., M). The longer the first exposure target duration is, the more reference frames the processor 140 captures to synthesize one result frame. On the contrary, the shorter the first exposure target duration is, the fewer reference frames the processor 140 captures to synthesize one result frame.

In some embodiments, the processor 140 may set a corresponding sliding window according to the first exposure target duration, and the sliding window is configured to select M reference frames from N original frames. By gradually moving the sliding window on the frame sequence, the processor 140 may sequentially retrieve multiple sets of reference frames from multiple consecutive original frames. For example, initially, the processor 140 may select the first original frame, the second original frame, and the third original frame according to the coverage of the sliding window to obtain the first set of reference frames. Then, the processor 140 may move the sliding window, and the processor 140 may select the 2nd original frame, the 3rd original frame and the 4th original frame according to the coverage of the sliding window to obtain the second set of reference frames. Different sets of reference frames may be used to synthesize different resulting images in a long-exposure video.

It should be noted that, in different embodiments, the M reference frames may be multiple consecutive original frames, or may also be multiple discontinuous original frames. For example, the processor 140 may select the first original frame, the third original frame, and the fifth original frame as three reference frames according to the coverage range of the sliding window.

In step S230, the processor 140 may perform image synthesis processing on the M first reference frames to obtain the result frame. Specifically, image synthesis processing is configured to combine multiple short-exposure images into one long-exposure image. In some embodiments, the processor 140 may perform superposition averaging processing on a plurality of first reference frames that are respectively short-exposure images to generate a result frame that is a long-exposure image. In more detail, the processor 140 may perform a superposition averaging process on M pixels corresponding to the same pixel position on the M first reference frames to obtain a pixel corresponding to the same pixel position on the result frame. In addition, in other embodiments, before performing image synthesis processing on the M first reference frames, the processor 140 may also perform image offset correction processing or dynamic object detection processing, etc., to obtain visually appealing long exposure images.

In step S240, the processor 140 may generate a long-exposure video including the result frame and having an output frame rate. It may be seen that multiple result frames in a long-exposure video may be generated sequentially by synthesizing multiple selected reference frames. These result frames may be saved in a video format to produce a long exposure video with an output frame rate.

That is to say, in some embodiments, the processor 140 may select M second reference frames from the N original frames according to the first exposure target duration. The processor 140 may perform the image synthesis processing on the M second reference frames to obtain another result frame. The long-exposure video also includes another result frame generated based on M second reference frames. The selection method of the M second reference frames may be similar to the selection method of the M first reference frames, and will not be described in detail here.

In some embodiments, a capture time interval of M first reference frames may overlap with a capture time interval of M second reference frames. As mentioned above, in some embodiments, the processor 140 may use a sliding window to respectively capture M first reference frames and M second reference frames. In other words, in some embodiments, part of the first reference frames is the same as part of the second reference frames. For example, the first reference frames may include the 1st original frame, the 2nd original frame, and the 3rd original frame, and the second reference frames may include the 2nd original frame, the 3rd original frame. frame and the 4th original frame.

In some embodiments, the input frame rate is equal to the output frame rate. Furthermore, since each result frame in the long-exposure video is generated based on a set of reference frames in the original frame, the output frame rate of the long-exposure video may be equal to the input frame rate of the original image. Moreover, under the condition of capturing original frames at a high input frame rate, the disclosure may still produce a long exposure video with dynamic long exposure effects and smooth playback.

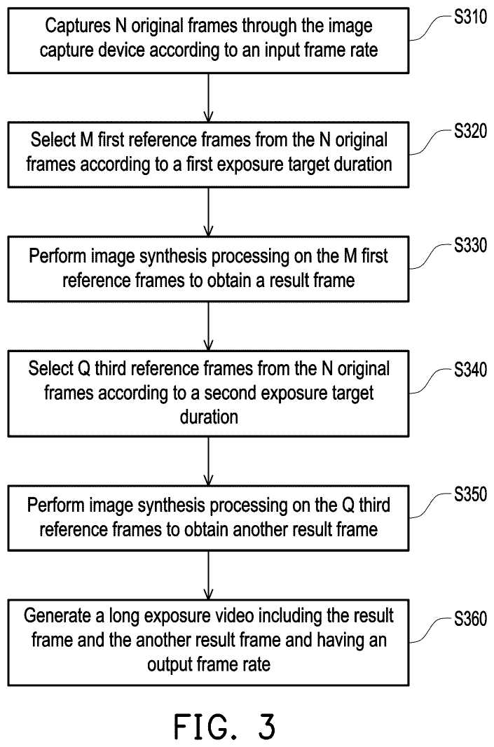

FIG. 3 is a flowchart of a long-exposure video generation method according to an embodiment of the disclosure. Referring to FIG. 3, the method of this embodiment may be executed by the electronic device 100 in FIG. 1. The details of each step in FIG. 2 will be described below with reference to the components shown in FIG. 1.

In step S310, the processor 140 may capture N original frames through the image capture device 120 according to an input frame rate. In step S320, the processor 140 may select M first reference frames from N original frames according to s first exposure target duration, wherein M is an integer greater than 1 and N is an integer greater than M. In step S330, the processor 140 may perform an image synthesis processing on the M first reference frames to obtain a result frame. The details of steps S310 to S330 may be described with reference to the foregoing embodiments, and will not be described again here.

In step S340, the processor 140 may select Q third reference frames from the N original frames according to a second exposure target duration, wherein Q is an integer greater than or equal to 1 and not equal to M. In some embodiments, the second exposure target duration is different from the first exposure target duration. In step S350, the processor 140 may perform the image synthesis processing on Q third reference frames to obtain another result frame.

Specifically, in some embodiments, the processor 140 may select the reference frame according to different exposure target durations. For example, during the shooting process, as the ambient light changes, the processor 140 may adjust the exposure target duration to select reference frames. Alternatively, when the sliding window corresponding to the first exposure target duration moves to the head or tail of a frame sequence that includes N original frames, it may not be possible to capture M reference frames. In such cases, the processor 140 can shorten the exposure target duration to select fewer reference frames.

In step S360, the processor 140 may generate a long-exposure video including the result frame and another result frame and having an output frame rate. That is, the long-exposure video includes a result frame corresponding to the first exposure target duration and another result frame corresponding to the second exposure target duration.

It should be noted that, as mentioned above, when the sliding window corresponding to the first exposure target duration moves to the head or tail of the frame sequence including N original frames, the processor 140 may be not able to capture M reference frames. Therefore, if M reference frames cannot be captured according to the sliding window corresponding to the first exposure target duration, the processor 140 may select Q reference frames with a shorter second exposure target duration, where Q is smaller than M.

In some embodiments, the result frame corresponding to the first reference frames is the i-th result frame of the long-exposure video. The processor 140 may select the (i−M+1)-th original frame to the i-th original frame among the N original frames according to the first exposure target duration, wherein i is greater than or equal to M and less than or equal to N. In other words, when generating the i-th result frame of the long exposure video (i.e., from the M-th result frame to the N-th result frame), the processor 140 may use the i-th original frame as the reference to select M reference frames from the preceding frames.

In some embodiments, the result frame corresponding to the third reference frames is the j-th result frame of the long-exposure video. The Q third reference frames include the 1st original frame to the j-th original frame among the N original frames, and j is greater than or equal to 1 and less than M. In other words, when generating the j-th result frame of the long exposure video (i.e., from the 1st resultant frame to the (M−1)-th resultant frame), the processor 140 may use the j-th original frame as the reference to select Q reference frames from the preceding frames, where Q is less than M.

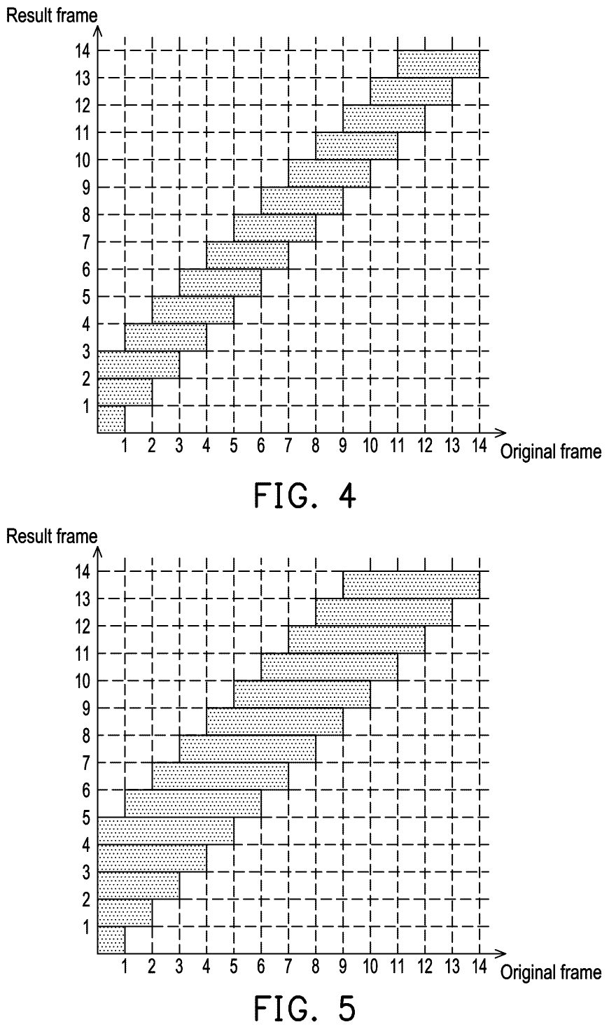

In order to make the concept of this embodiment easier to understand, examples in FIG. 4 and FIG. 5 will be described below. However, FIG. 4 and FIG. 5 are only examples for illustrating the disclosure and are not intended to limit the disclosure. Referring to FIG. 4, assuming that the input frame rate of the original frame is 30 FPS, M=3 and N=14. In this example, when generating the first (j=1 and less than M) result frame, the processor 140 may select the first original frame as the reference frame. In this case, the first result frame may be the first original frame. When generating the second (j=2 and less than M) result frame, the processor 140 may select the first original frame and the second original frame as two reference frames. Therefore, the processor 140 performs image synthesis processing on the first original frame and the second original frame to generate a second result frame.

When generating the third (j=3 and equal to M) result frame, the processor 140 may select the first original frame, the second original frame and the third original frame as three reference frames. Therefore, the processor 140 performs image synthesis processing on the first to third original frames to generate a third result frame. Following the same principle, the processor 140 may sequentially capture 3 reference frames to synthesize the 4th to the 14th resultant frames. Thus, in the example shown in FIG. 4, the output frame rate of the long exposure video is also 30 FPS. Additionally, the correspondence between the original frames and the resultant frames is as follows:

$$R {F}_{i} = Process ( {IF}_{i - M + 1} to {IF}_{i} ) , for M \leq i \leq N$$

$$R {F}_{j} = Process ( {IF}_{1} to {IF}_{j} ) , for 1 \leq j \leq M - 1$$

wherein, RF represents the result frame; IF represents the original frame; Process(⋅) represents the image synthesis process.

In addition, Referring to FIG. 5, assuming that the input frame rate of the original frame is 30 FPS, M=5 and N=14. The processor 140 may respectively select 5 reference frames from the 14 original frames to generate each result frame according to the corresponding relationship as shown in FIG. 5. For example, the processor 140 may synthesize the fourth result frame based on the first to fourth original frames. The processor 140 may synthesize the fifth result frame based on the first to fifth original frames. The difference between the example shown in FIG. 5 and the example shown in FIG. 4 is the difference in M.

In some embodiments, the result frame corresponding to the first reference frames is the i-th result frame of the long-exposure video. The processor 140 may select the i-th original frame to the (i+M−1)-th original frame among the N original frames according to the first exposure target duration, wherein i is greater than or equal to 1 and less than or equal to NM 1. In other words, when generating the i-th result frame (i.e., the 1st result frame to the (N−M+1)-th result frame) of the long-exposure video, the processor 140 may use the i-th original frame as the reference and select M reference frames from the subsequent frames.

Furthermore, in some embodiments, the result frame corresponding to the third reference frames is the j-th result frame of the long-exposure video. The Q third reference frames include the j-th original frame to the N-th original frame among the N original frames, and j is greater than NM 1 and less than or equal to N. In other words, when generating the j-th result frame (i.e., the (N−M+2)-th result frame to the N-th result frame) of the long-exposure video, the processor 140 may use the j-th original frame as the reference and select Q reference frames from the subsequent frames, wherein Q is less than M.

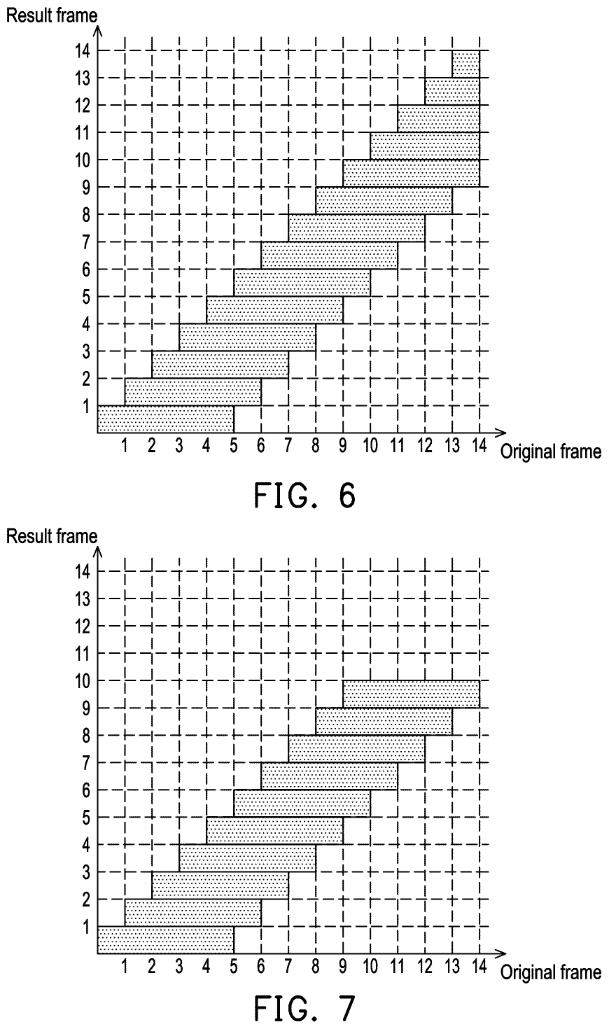

In order to make the concept of this embodiment easier to understand, examples in FIG. 6 and FIG. 7 will be described below. However, FIG. 6 and FIG. 7 are only examples for illustrating the disclosure and are not intended to limit the disclosure. Please referring to FIG. 6, assuming that the input frame rate of the original frame is 30 FPS, M=5 and N=14. In this example, when generating the first (j=1 and less than or equal to N−M+1) result frame, the processor 140 may select the first to fifth original frames as reference frames. Based on the same principle, the processor 140 may sequentially select 5 reference frames to synthesize the second to tenth result frames.

When the 11th (j=11 and greater than N−M+1) result frame is to be generated, the processor 140 may select the 11th original frame, the 12th original frame, the 13th original frame and the 14th original frame as 4 reference frames. Therefore, the processor 140 may perform the image synthesis processing on the 11th original frame to the 14th original frame to generate the 11th result frame. When the 12th (j=12 and greater than N−M+1) result frame is to be generated, the processor 140 may select the 12th original frame, the 13th original frame and the 14th original frame as three reference frames. Therefore, the processor 140 may perform image synthesis processing on the 12th original frame to the 14th original frame to generate the 12th result frame.

When the 13th (j=13 and greater than N−M+1) result frame is to be generated, the processor 140 selects the 13th original frame and the 14th original frame as two reference frames to generate the 13th result. Frame. When the 14th (j=14 and greater than N−M+1) result frame is to be generated, the processor 140 may select the 14th original frame as a reference frame to generate the 14th result frame. In this case, the 14th result frame may be the 14th original frame.

As a result, in the example in FIG. 6, the output frame rate of the long-exposure video is also 30 FPS. In addition, the corresponding relationship between the original frame and the result frame is as follows:

$$R {F}_{i} = Process ( {IF}_{i} to {IF}_{i + M - 1} ) , for 1 \leq i \leq N - M + 1$$

$$R {F}_{j} = Process ( {IF}_{j} to {IF}_{N} ) , for N - M + 2 \leq j \leq N$$

wherein, RF represents the result frame; IF represents the original frame; Process(⋅) represents the image synthesis process.

In addition, referring to FIG. 7, in some embodiments, when the sliding window moves to the sequence head or the sequence tail of the frame sequence and M reference frames cannot be captured, the processor 140 may discard using the first few or last few original frames to synthesize the result frames in the long exposure video. As shown in FIG. 7, the processor 140 may omit generating the 11th to 14th result frames. In the example of FIG. 7, the corresponding relationship between the original frame and the result frame is as follows:

$$R {F}_{i} = Process ( {IF}_{i} to {IF}_{i + M - 1} ) , for 1 \leq i \leq N - M + 1$$

wherein, RF represents the result frame; IF represents the original frame; Process(⋅) represents the image synthesis process.

In some embodiments, during the process of generating a long-exposure video, the shooting preview screen of the display 110 may display the result frame in real time, so that the photographer may know whether the long exposure effect is as expected.

To sum up, in embodiments of the disclosure, multiple reference frames may be extracted from the original frames according to the exposure target duration, and the multiple reference frames may be synthesized into one result frame in the long-exposure video. Therefore, without reducing the capture frame rate of the original frame, the disclosure may generate a long-exposure video with a dynamic long exposure effect, and the output frame rate of the long exposure effect may be equal to the input frame rate of the original frame. Based on this, the problem that the frame rate of long-exposure images is limited due to extending the exposure time of a single frame may be solved, and the breakage of the light track in long-exposure videos may be avoided. In addition, since the disclosure may dynamically adjust the exposure target duration, the photographer may obtain long-exposure videos with different visual effects. This disclosure also maintains the smoothness of long-exposure videos and avoids changes in the perception of time.

Although the disclosure has been described in terms of embodiments, they are not intended to limit the disclosure. Anyone with ordinary knowledge in the relevant technical field may make slight changes and modifications without departing from the spirit and scope of the disclosure. Therefore, the scope of protection of the disclosure shall be determined by the scope of the appended application.

What is claimed is:

1. A long-exposure video generation method, adapted to an electronic device comprising an image capture device, and comprising:
capturing N original frames according to an input frame rate through the image capture device;
selecting M first reference frames from the N original frames according to a first exposure target duration, where M is an integer greater than 1 and N is an integer greater than M;
performing an image synthesis processing on the M first reference frames to obtain a result frame; and
generating a long-exposure video comprising the resulting image frame and having an output frame rate.

2. The long-exposure video generation method according to claim 1, wherein the input frame rate is equal to the output frame rate.

3. The long-exposure video generation method according to claim 1, further comprising:
selecting M second reference frames from the N original frames according to the first exposure target duration; and
performing image synthesis processing on the M second reference frames to obtain another result frame, wherein the long-exposure video further comprises the another result frame.

4. The long-exposure video generation method according to claim 3, wherein a capture time interval of the M first reference frames overlaps with a capture time interval of the M second reference frames.

5. The long-exposure video generation method according to claim 1, wherein the result frame is a i-th result frame of the long-exposure video, and the step of selecting the N original frames from the N original frames according to the first exposure target duration comprises:
selecting the i-th original frame to the (i+M−1)-th original frame among the N original frames according to the first exposure target duration, wherein i is greater than or equal to 1 and less than or equal to N−M+1.

6. The long-exposure video generation method according to claim 1, wherein the result frame is the i-th result frame of the long-exposure video, and the step of selecting the N original frames from the N original frames according to the first exposure target duration comprises:
selecting the (i−M+1)-th original frame to the i-th original frame among the N original frames according to the first exposure target duration, wherein i is greater than or equal to M and less than or equal to N.

7. The long-exposure video generation method according to claim 1, further comprising:
selecting Q third reference frames from the N original frames according to a second exposure target duration, wherein Q is an integer greater than or equal to 1 and not equal to M, and the second exposure target duration is different from the first exposure target duration; and
performing the image synthesis processing on the Q third reference frames to obtain another result frame, wherein the long-exposure video further comprises the another result frame.

8. The long-exposure video generation method according to claim 7, wherein the Q third reference frames comprise the j-th original frame to the N-th original frame among the N original frames, and j is greater than N−M+1 and less than or equal to N.

9. The long-exposure video generation method according to claim 7, wherein the Q third reference frames comprise the first original frame to the j-th original frame among the N original frames, and j is greater than or equal to 1 and less than M.

10. An electronic device, comprising:
an image capture device; and
a processor coupled to the image capture device and configured to:
capture N original frames according to an input frame rate through the image capture device;
select M first reference frames from the N original frames according to a first exposure target duration, where M is an integer greater than 1 and N is an integer greater than M;
perform an image synthesis processing on the M first reference frames to obtain a result frame; and
generate a long-exposure video comprising the resulting image frame and having an output frame rate.

11. The electronic device according to claim 10, wherein the input frame rate is equal to the output frame rate.

12. The electronic device according to claim 10, wherein the processor is further configured to:
select M second reference frames from the N original frames according to the first exposure target duration; and
perform the image synthesis processing on the M second reference frames to obtain another result frame, wherein the long-exposure video further comprises the another result frame.

13. The electronic device according to claim 10, wherein a capture time interval of the M first reference frames overlaps with a capture time interval of the M second reference frames.

14. The electronic device according to claim 10, wherein the result frame is a i-th result frame of the long-exposure video, and the processor is further configured to:
select the i-th original frame to the (i+M−1)-th original frame among the N original frames according to the first exposure target duration, wherein i is greater than or equal to 1 and less than or equal to N−M+1.

15. The electronic device according to claim 10, wherein the result frame is the i-th result frame of the long-exposure video, and the processor is further configured to:
select the (i−M+1)-th original frame to the i-th original frame among the N original frames according to the first exposure target duration, wherein i is greater than or equal to M and less than or equal to N.

16. The electronic device according to claim 10, wherein the processor is further configured to:
select Q third reference frames from the N original frames according to a second exposure target duration, where Q is an integer greater than or equal to 1 and not equal to M, and the second exposure target duration is different from the first exposure target duration; and
perform the image synthesis processing on the Q third reference frames to obtain another result frame, wherein the long-exposure video further comprises the another result frame.

17. The electronic device according to claim 16, wherein the Q third reference frames comprise the j-th original frame to the N-th original frame among the N original frames, and j is greater than N−M+1 and less than or equal to N.

18. The electronic device according to claim 16, wherein the Q third reference frames comprise the first original frame to the j-th original frame among the N original frames, and j is greater than or equal to 1 and less than M.
